(19) United States
(12) Patent Application Publication
(10) Pub. No.: US 2007/0102537 A1
(43) Pub. Date: May 10, 2007

(54) Ultrasonic standing-wave atomizer arrangement

(75) Inventors: Gert Stauch, Wiesloch/Baiertal (DE); Matthias Bjoern, Bad Schoenborn (DE); Uwe Goerges, Bochum (DE); Gunter Boerner, Sinsheim/Eschelbach (DE); Hidetoshi Yamabe, Tokyo (JP); Horst Doerlich, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, LADENBURG (DE)

(21) Appl. No.: 10/560,908

(22) PCT Filed: May 29, 2004
(86) PCT No.: PCT/EP04/05866

§ 371 Date: Jun. 15, 2006

(30) Foreign Application Priority Data
Jun. 18, 2003 (DE) 103 27 429.4

(51) Int. Cl. B05B 1/08

(52) U.S. Cl. 239/102.1; 239/290; 239/291; 239/548

(57) ABSTRACT

The invention relates to an ultrasonic standing-wave atomizer arrangement for producing a paint spray mist for painting a workpiece, with a sonotrode, with a component arranged lying opposite the sonotrode, a standing ultrasonic field being formed in the intermediate space between the sonotrode and the component in the case of operation, and with at least one paint feeding device, which introduces the paint into the intermediate space for the atomizing process at at least one paint discharge point. An air supply device, interacts with at least one air distribution device. The air distribution device has a number of clearances, which serve for blowing out air, the clearances being arranged in such a way that between the at least one paint discharge point and the sonotrode, and also between the at least one paint discharge point and the component, there is formed at least one region with a blocking air flow, by which air flow wetting of the sonotrode or of the component with paint is substantially avoided.

The invention relates to an ultrasonic standing-wave atomizer arrangement for producing a paint spray mist for painting a workpiece, with a sonotrode, with a component arranged lying opposite the sonotrode, serving as a reflector, a standing ultrasonic field being formed in the intermediate space between the sonotrode and the component in the case of operation, and with at least one paint feeding device, which introduces the paint into this intermediate space for the atomizing process at at least one paint discharge point.

For painting workpieces, for example in painting processes in the automobile industry, at present the generally known high-speed rotary atomizers are used in particular. In the case of this type of atomizing, the paint is initially directed onto the inner side of a metal bell, which is driven by a compressed-air turbine and in such a way rotates at up to 80,000 revolutions per minute. In such a way, the paint reaches the front side of a metal bell, facing the workpiece, and, on account of the centrifugal forces acting there, breaks away at the edge of the bell into fine droplets. In this way, until now a droplet size of the paint spray mist in the range from 10¼ m to 60¼ m has been achieved, which represents adequate quality for the painting process.

Generally known considerations of the fundamentals are concerned with whether, in principle, paint can also be atomized by means of an ultrasonic standing-wave atomization. In tests following these considerations of the principles concerned, however, average drop sizes during atomization of between 100¼ m and 200¼ m have been measured, with some instances of still larger drops also being produced. Such large drops adversely influence the quality of the coat of paint in such a way as to make use in painting technology impracticable.

Furthermore, DE 10245326.8 (Mp No. 02/625) and DE 10245324.1 (Mp No. 02/626) disclose an ultrasonic standing-wave atomizer, for producing a paint spray mist, the paint particles of which are small enough to produce a coat of paint of adequate quality on the workpiece to be painted. Specific configurations of the paint feeding device, the sonotrode and on the component are provided for this.

However, a disadvantage of these arrangements is that, on account of the comparatively compact arrangement, the components of the ultrasonic standing-wave atomizer arrangement, in particular the sonotrode and the component, are soiled comparatively quickly as a result of being wetted by atomized paint particles. Accordingly, the components soiled in this way must be cleaned at corresponding time intervals. This causes a not inconsiderable expenditure in terms of time and also, associated with this, in terms of cost.

On the basis of this prior art, the object of the invention is to provide an ultrasonic standing-wave atomizer arrangement which is less susceptible to contamination of the components, in particular the sonotrode and the component, by atomized paint particles.

This object is achieved according to the invention by an ultrasonic standing-wave atomizer arrangement with the features specified in claim 1.

Accordingly, in the case of the ultrasonic standing-wave atomizer arrangement mentioned at the beginning there is an air supply device, which interacts with at least one air distribution device. The air distribution device has a number of clearances, which serve for blowing out air. In this case, the clearances are arranged in such a way that between the at least one paint discharge point on the one hand and the sonotrode and also the component serving as a reflector on the other hand there is formed in each case at least one region with a blocking air flow, the blocking air flow to the greatest extent preventing the sonotrode or the component from being wetted with paint.

In a way corresponding to an advantageous development of the invention, the at least one air distribution device is formed as a box-shaped hollow body or a corresponding piece of pipe. Here, in a further improvement of the invention, two air distribution devices are provided, by which two blocking air flows that are independent of one another can be formed.

In a development according to the invention, the clearances in the air distribution device are configured as round nozzles. Here it proves to be a further advantage of the invention that the clearance of each air distribution device are respectively arranged in at least one row along a straight line which run parallel to the plane formed by the end sides of the sonotrode and of the component serving as a reflector. In a row under consideration, the clearances are preferably arranged at the same distances from one another, an additional advantage being that the air emerging from the clearances of each row forms a blocking air flow.

A preferred configuration of the invention is distinguished by the fact that the at least one air distribution device is at such a distance from the at least one paint discharge point and from the sonotrode or from the component that the intensity of the air flow required to avoid wetting is obtained, it being required for the intensity to be empirically determined.

In a development of the invention, it may also be provided that the clearances for the discharge of air of an air distribution device are arranged along at least two imaginary straight lines, the at least two straight lines preferably also running parallel to one another. In addition, it is advantageous to arrange the clearances of one row offset with respect to the clearances of the neighboring row.

According to an alternative or additional development of the invention, it may be provided that the clearances at one air distribution device are arranged along two straight lines, the at least two straight lines running parallel to one another and the blocking air flows caused by the respective rows being directed at a fixed or variable angle in relation to one another, so that the overall intensity of the overall blocking air flows formed by the individual blocking air flow, in particular in the intermediate space, is comparatively small.

A further configuration according to the invention provides that the air distribution device is formed in a displaceable and/or pivotable manner for the purpose of influencing the form of the paint spray cone of the atomized paint, that is to say is in particular pivotable about a pivot axis which runs parallel to one of the straight lines.

According to a further preferred configurational variant, the ultrasonic standing-wave atomizer arrangement according to the invention may have at least one directing-air distribution device, which interacts with the at least one air supply device, the directing-air distribution device having a number of openings, which serve for the directed blowing out of air. The blown-out air serves here for influencing the form of the atomized paint and so forms a region with directing air flow.

Accordingly, the at least one directing-air distribution device may be formed as a box-shaped hollow body or as a corresponding piece of pipe. Here, the openings for the air are advantageously likewise configured as round nozzles, the at least one region of the directing air flow being formed approximately in the form of a cuboid or in the form of a fan by corresponding arrangement of the opening.

A further preferred variant of the invention provides that the opening of the directing-air distribution device are arranged along at least one straight line, the straight line running parallel to a further straight line in which clearance of an air distribution device assigned to the directing-air distribution device are arranged. The openings may advantageously be arranged offset in relation to the clearances. The clearances also preferably take the form of nozzles.

According to the invention, the regions of the directing air flows, optionally also in combination with the regions of blocking air flows, advantageously form a tunnel-like air flow enclosing the atomized paint. Here it proves to be favorable that the at least one directing-air distribution device is formed in a displaceable and/or pivotable manner for the purpose of influencing the form of the paint spray cone, it being arranged in one particular embodiment such that it is pivotable about the longitudinal axis of the respective directing-air distribution device.

According to a further embodiment of the invention, it is provided that the at least one air distribution device and/or the at least one directing-air distribution device are respectively subdivided into two segmental elements, each segmental element having at least one, preferably nozzle-shaped, clearance or a passage, and the blowing-out direction of the air being separately settable in each case for each segmental element of an air distribution device or a directing-air distribution device. The setting preferably takes place by pivoting the nozzle, whereby a form of the paint spray cone that is adapted to the respective requirement being made possible.

Furthermore, the at least one air distribution device or the at least one directing-air distribution device has a blocking element, which in an advantageous development is provided with at least one clearance or a passage and serves for the setting of the blowing-out intensity of the air flow, in that it blocks or entirely or partly releases the clearance or the passage. According to one embodiment, the blocking element is configured as a rotation block.

Similarly, the at least one directing-air distribution device may have a directing-air distributing element, which is pivotably mounted in a holding element. In this case, at least two different arrangements of apertures may be arranged on the directing air distributor, in each arrangement of the apertures a region with a directing air flow being formed and, depending on the pivoting position of the directing-air distributor element, an arrangement for the blowing out of air being released or closed.

A preferred development of the invention provides that the holding element is pivotable about the axis of rotation of the directing-air distributing element. Here, the holding element may have a passage point, within which a predetermined arrangement of apertures for setting the discharge cross section is adjustable.

A further configurational variant of the ultrasonic standing-wave atomizer arrangement according to the invention has a first distributor element, which interacts with the air supply device, the first distributor element reaching around the sonotrode and/or the component. Furthermore, arranged on the distributor element are first passages, through which air can flow out in a directed manner, the directed air flow serving for forming an air cushion between the end face of the sonotrode or of the component that is facing the intermediate space and the at least one paint discharge point.

In a way corresponding to an alternative development of the invention, it proves to be favorable that the component and/or the sonotrode interact with the air supply device, second passages through which air flows out in a directed manner being arranged on the component and the sonotrode, respectively. Here, too, the directed air flow respectively serves for the formation of an air cushion between the end face of the component or of the sonotrode that is facing the intermediate space on the one hand and the at least one paint discharge point on the other hand.

To further improve the discharge behavior of the ultrasonic standing-wave atomizer arrangement according to the invention, the air conduction of the first distributor element at the sonotrode and/or at the component may be subdivided into segments, their supply with air respectively being provided separately.

In a further configuration, a second distributor element may also be arranged on the side of the intermediate space lying opposite the spraying direction of the atomized paint. The second distributing element serves for producing an air flow which completely encloses the atomized paint in the vicinity of the at least one paint discharge point and at least partly carries it along. By means of the arrangement and alignment of apertures, the profile of the air flow on the side of the second distributing element that is facing the at least one paint discharge point is advantageously predeterminable. This allows a twist about the longitudinal direction of the spraying direction to be imparted to the air flow by the arrangement and alignment of the apertures, by which twist the profile of the paint spray cone can be precisely set.

According to an advantageous embodiment of the ultrasonic standing-wave atomizer arrangement according to the invention, the respectively provided air distributors, in particular the directing air distributors, are arranged in what are known as magazines, which have an adequate opening cross section, so that only the row of nozzles respectively intended for operation, that is the apertures arranged in a row, are free, while the not intended apertures are closed, that is to say covered.

A further preferred configurational variant provides that, in the vicinity of the at least one paint discharge point, the free ends of pieces of pipe are respectively arranged, air flowing out in a directed manner through each piece of pipe, which outflowing air to the greatest extent prevents a recombination of different sheets of the atomized paint.

Similarly, in a further configuration of the invention it may be favorable that, in addition to the already described air distribution components, further components intended for air distribution are arranged downstream in the paint spraying direction below the intermediate space, and that the air of the spray cones of the atomized paint flowing out from the air distribution elements spatially re-forms after the atomization phase in the intermediate space and if need be accelerates the paint particles.

In the case of a further alternative for the configuration of the ultrasonic standing-wave atomizer according to the invention, the edge region of the sonotrode on the one hand and the end face of the reflector on the other hand are provided with air discharge nozzles, through which air flows out in a directed manner and impinges on the paint spray cone located in between. Instead of an edge region of the sonotrode provided with nozzles, a correspondingly configured ring which is pushed onto the sonotrode or fitted onto the sonotrode may preferably also be provided.

In the case of a further configuration of the ultrasonic standing-wave atomizer arrangement according to the invention, in addition to the air distributors and directing-air distributors arranged in the plane of the end faces of the sonotrode and of the reflector component, further air flow blocks are provided, covering the lateral flanks between the end faces of the sonotrode and the reflector component with air flowing out in a directed manner. This allows an exact geometry of the paint spray mist fed from the paint feeding device to be set, with which for example virtually the entire cross sections bounded by the two planes parallel to the end faces of the sonotrode and the reflector component and also the straight lines joining them is filled with paint spray mist.

These and other configurational features of the invention are the subject of the subclaims.

The invention, advantageous configurations and improvements of the invention are to be explained and described in more detail on the basis of exemplary embodiments that are represented in the description of the figures together with the figures, in which:

FIG. 1 shows an oblique view of an arrangement for standing-wave atomization, with a sonotrode and a reflector arranged diametrically opposite the sonotrode, and a tubular paint feeding device introduced in between;

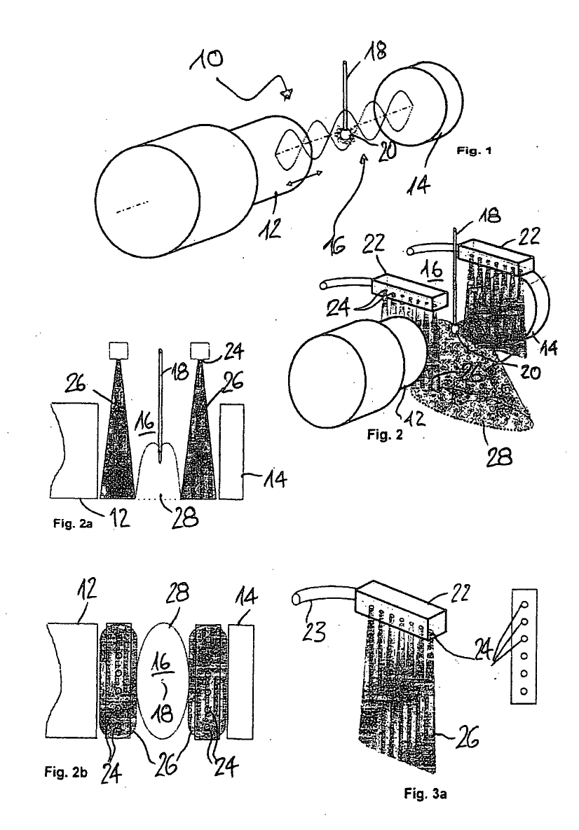

FIG. 2 shows an oblique view of an arrangement for standing-wave atomization corresponding to FIG. 1, with a device for producing an air curtain;

FIG. 2a shows an arrangement according to FIG. 2 from the side,

FIG. 2b shows an arrangement according to FIG. 2 from below;

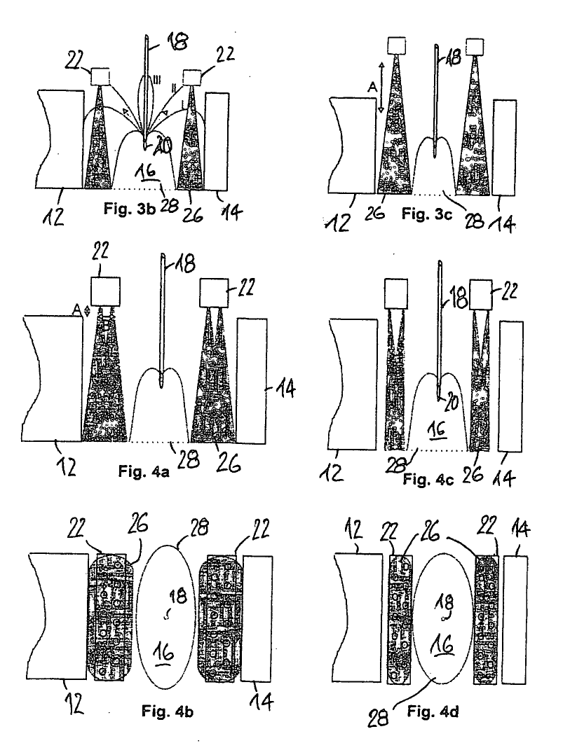

FIG. 3a shows an air distributor for producing an air curtain in an oblique view;

FIG. 3b shows an arrangement according to FIG. 2a width defective cleaning air;

FIG. 3c shows an arrangement according to FIG. 2a with entered parameters;

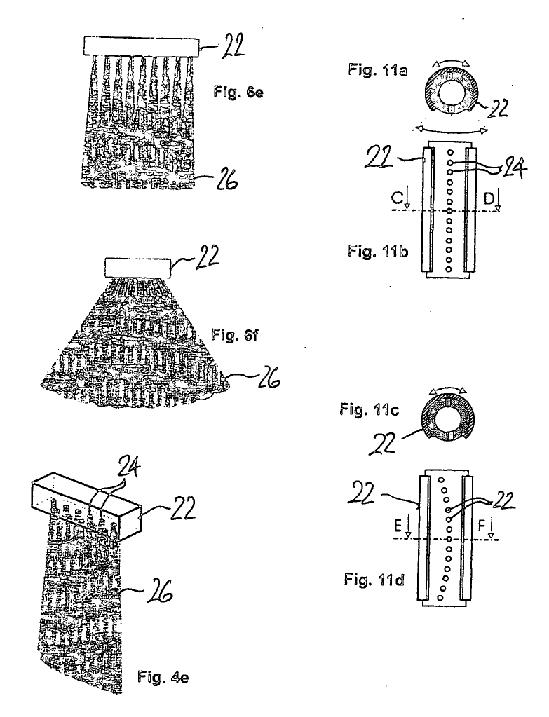

FIG. 4a shows an arrangement according to FIG. 2a with a first nozzle arrangement with parallel air conduction;

FIG. 4b shows an arrangement according to FIG. 4a from below;

FIG. 4c shows an arrangement according to FIG. 2a with a first nozzle arrangement with inwardly inclined air conduction;

FIG. 4d shows an arrangement according to FIG. 4c from below;

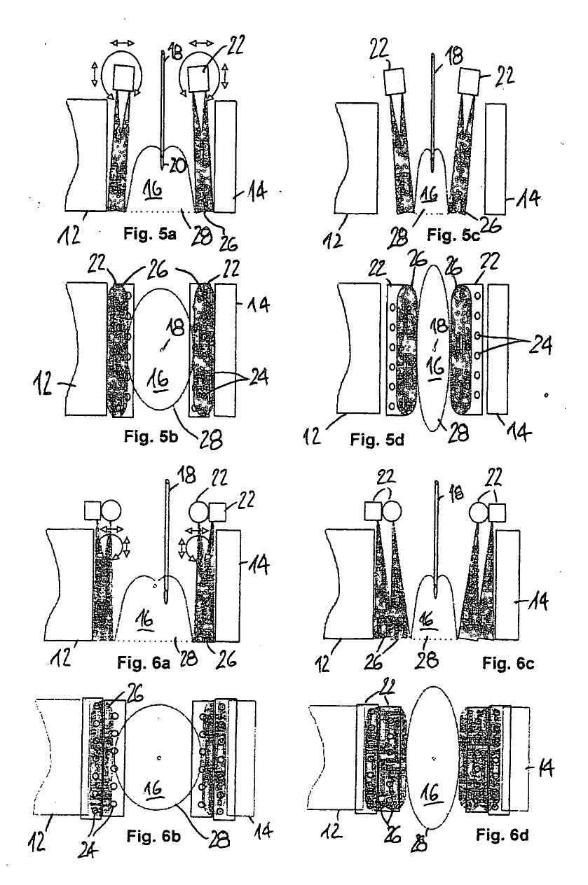

FIG. 5a shows an arrangement according to FIG. 4a width pivotable and/or displaceable air conduction,

FIG. 5b shows an arrangement according to FIG. 5a from below;

FIG. 5c shows an arrangement according to FIG. 4c with pivotable and/or displaceable air conduction;

FIG. 5d shows an arrangement according to FIG. 5c from below;

FIG. 6a shows an arrangement according to FIG. 2a with a second nozzle arrangement with pivotable and/or displaceable directing air distributors for producing a round spray cross section;

FIG. 6b shows an arrangement according to FIG. 6a from below;

FIG. 6c shows an arrangement according to FIG. 2a with a second nozzle arrangement with pivotable and/or displaceable directing air distributors for producing an oval spray cross section;

FIG. 6d shows an arrangement according to FIG. 6c from below;

FIG. 6e shows a side view of a directing air conductor for producing a parallel directing air envelope;

FIG. 6f shows a side view of a directing air conductor for producing a fanned-out directing air envelope;

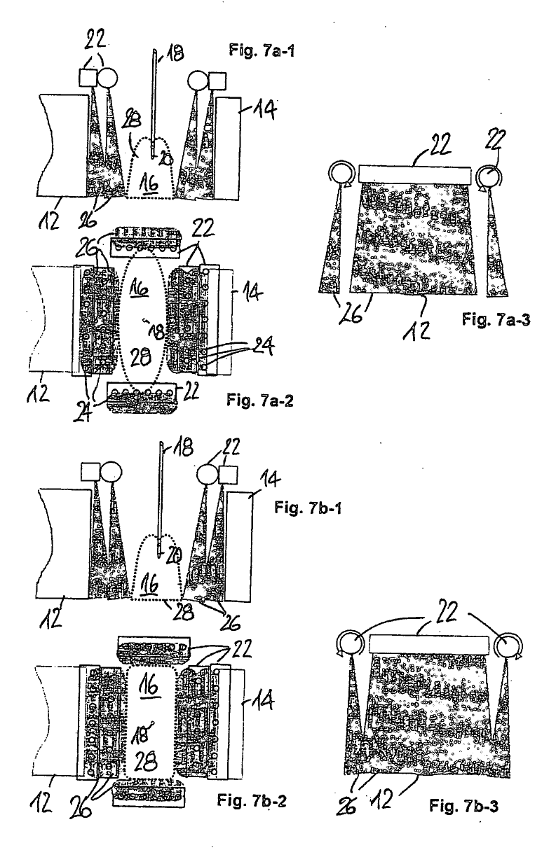

FIG. 7a-1 shows an arrangement according to FIG. 6a with additional laterally arranged directing air distributors, the directing air of which is outwardly directed;

FIG. 7a-2 shows an arrangement according to FIG. 7a-1 from below;

FIG. 7a-3 shows an arrangement according to FIG. 7a-1 from the side;

FIG. 7b-1 shows an arrangement according to FIG. 6a with additional laterally arranged directing air distributors, the directing air of which is inwardly directed;

FIG. 7b-2 shows an arrangement according to FIG. 7b-1 from below;

FIG. 7b-3 shows an arrangement according to FIG. 7b-1 from the side;

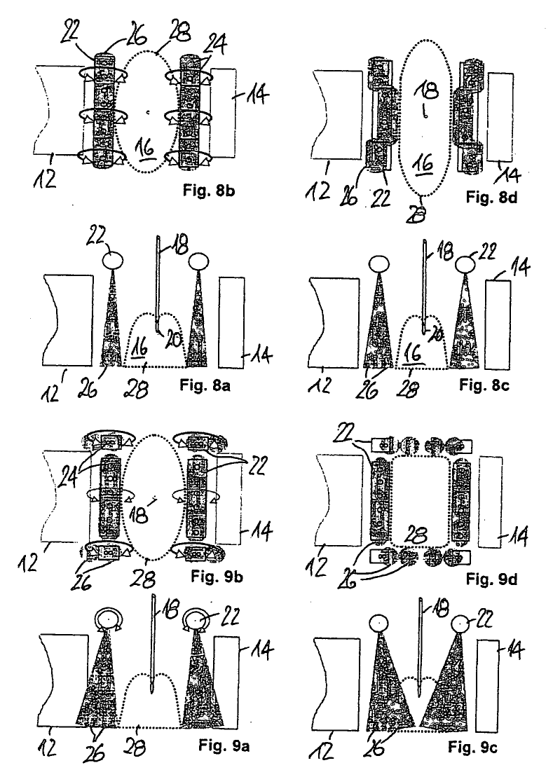

FIG. 8a shows an arrangement according to FIG. 2 with a third nozzle arrangement, with segmented, variably settable directing air distributors with parallel directing air conduction;

FIG. 8b shows an arrangement according to FIG. 8a from below;

FIG. 8c shows an arrangement according to FIG. 2 with a third nozzle arrangement, with segmented, variably settable directing air distributors with offset directing air conduction;

FIG. 8d shows an arrangement according to FIG. 8c from below;

FIG. 9a shows an arrangement according to FIG. 2a with a third nozzle arrangement, with segmented, variably settable directing air distributors and with additional, laterally arranged directing air distributors with parallel, outwardly directed directing air conduction for producing an elongated-oval spray pattern;

FIG. 9b shows an arrangement according to FIG. 9a from below;

FIG. 9c shows an arrangement according to FIG. 2 with a third nozzle arrangement, with segmented, variably settable directing air distributors and with additional, laterally arranged directing air distributors with parallel, inwardly directed directing air conduction for producing a rectangular spray pattern;

FIG. 9d shows an arrangement according to FIG. 9c from below;

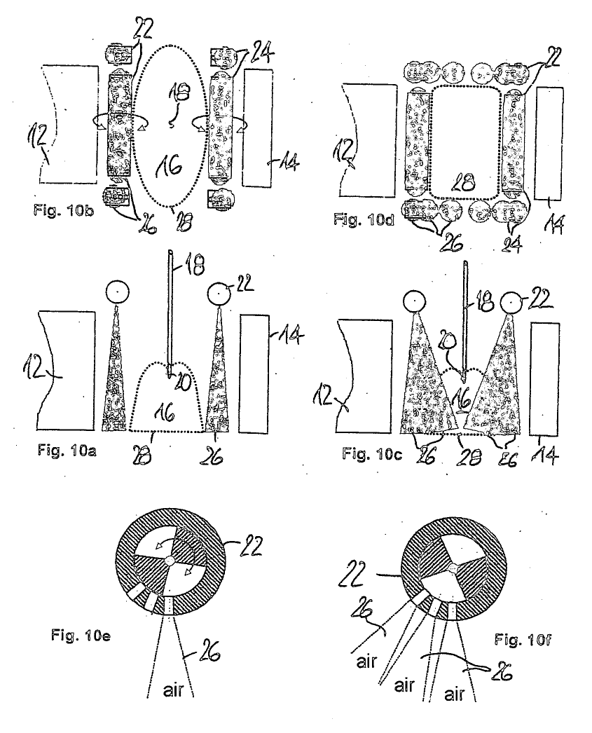

FIG. 10a shows an arrangement according to FIG. 9a with a partly blocked-off feed for lateral directing air;

FIG. 10b shows an arrangement according to FIG. 10a from below;

FIG. 10c shows an arrangement according to FIG. 9a with an open feed for lateral directing air;

FIG. 10d shows an arrangement according to FIG. 10a from below;

FIG. 10e shows a partly closed rotation block for directing air in cross section;

FIG. 10f shows an opened rotation block for directing air in cross section;

FIG. 11a shows a pivotable directing air distributor in cross section along sectional line C-D;

FIG. 11b shows the directing air distributor according to FIG. 11a with a linear nozzle characteristic in longitudinal view;

FIG. 11c shows a pivotable directing air distributor in cross section along sectional line E-F;

FIG. 11b shows the directing air distributor according to FIG. 11a with a linear nozzle characteristic in longitudinal view;

FIG. 11c shows a pivotable directing air distributor in cross section along sectional line E-F;

FIG. 11d shows a directing air distributor according to FIG. 11c with a curved nozzle characteristic in longitudinal view;

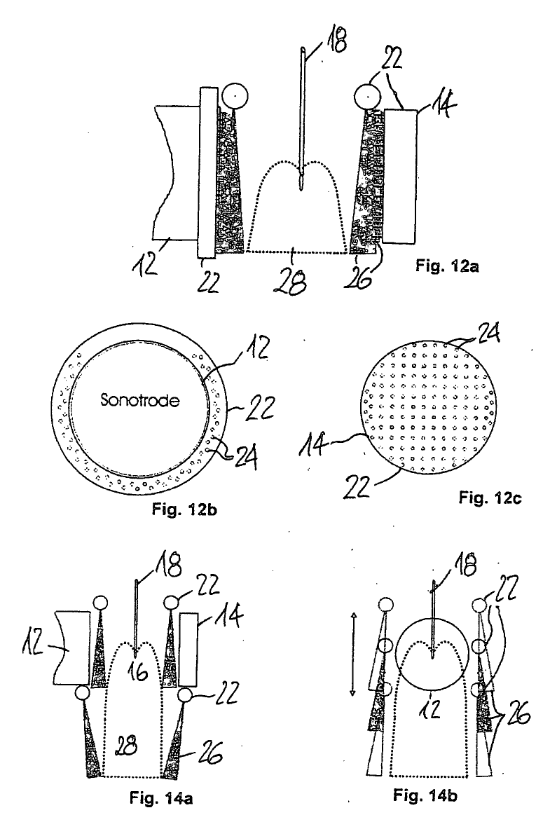

FIG. 12 shows an arrangement according to FIG. 1 in side view, with nozzles for directing air and/or for cleaning air respectively arranged on the sonotrode and on the reflector and lying in the plane of sound propagation,

FIG. 12a shows a ring with round nozzles for enclosing the sonotrode;

FIG. 12b shows a reflector with a nozzle;

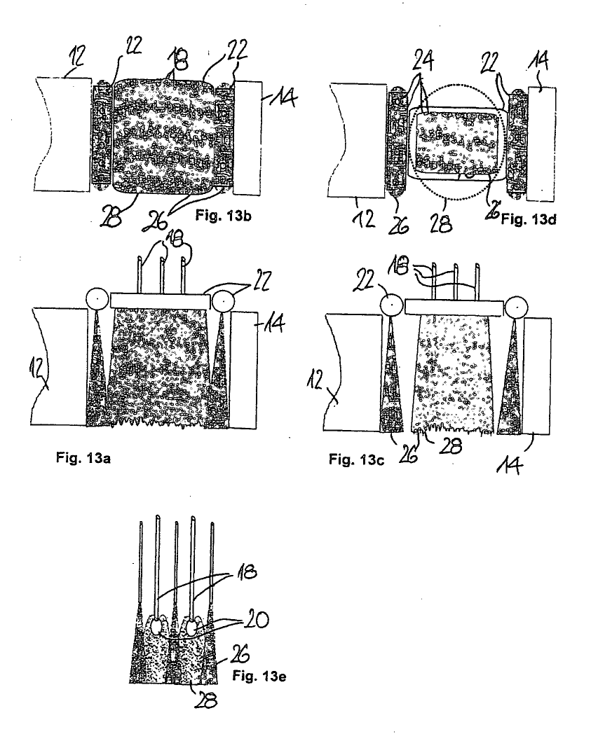

FIG. 13a shows an arrangement according to FIG. 2, with an air box for directing and/or is cleaning air, covering the intermediate space between the sonotrode and the reflector, with distributed air nozzles and with 3 tubular paint spray nozzles penetrating the air box;

FIG. 13b shows an arrangement according to FIG. 13a from below;

FIG. 13c shows an arrangement according to FIG. 2a, with an air box for directing and/or cleaning air, covering the intermediate space between the sonotrode and the reflector, with individual air nozzles and with 3 tubular paint spray nozzles penetrating the air box;

FIG. 13d shows an arrangement according to FIG. 13c from below;

FIG. 13e shows a variant with needle-valve nozzles for air arranged close to the discharge openings of the paint nozzles;

FIG. 14a shows an arrangement according to FIG. 2 with air conductors for directing air, arranged underneath in the jetting direction, for re-acceleration and re-formation of the paint spray cone;

FIG. 14b shows a variant of the configuration shown in FIG. 14a.

In FIG. 1, the basic principle for the coating of paint by means of standing-wave atomization is represented on the basis of an arrangement 10, which comprises an approximately circular-cylindrical sonotrode 12 and a reflector 14 of approximately the same cross section. The sonotrode 12 is used to produce ultrasonic waves, which are thrown back at the opposite reflector 14, the distance between the sonotrode 12 and the reflector 14 being dimensioned so as to form a standing US wave which fills the intermediate space 16.

Protruding into the space 16 formed between the sonotrode 12 and the reflector 14 is the free end of a tubular paint discharge nozzle 18. When it emerges from the nozzle 18, there form sheets of paint 20, which are acted on by the ultrasonic standing-wave field located there and are atomized as a result.

If no additional energy is supplied, the paint mist produced in such a way remains in the intermediate space 16 and is deposited on the end faces of the sonotrode 12 and the reflector 14.

In FIG. 2, the arrangement 10 known from FIG. 1 is supplemented by air distributors 22 arranged on both sides of the paint nozzle 18, with a first nozzle arrangement of round air nozzles 24. The air fed from the air distributors 22 forms an air curtain 26, which shields the end face of the sonotrode 12 and the reflector 14 from the paint mist and at the same time provides the formation of a paint spray cone 28 facing in the direction of the air flow.

It can be seen from the side view of the previously described arrangement 10 that is shown in FIG. 2a that the paint mist is in this way formed by means of the air curtain 26 into a spray cone 28, which has an oval cross section in a way corresponding to the view from below shown in FIG. 2b.

Further details of the operating mode of the air distributors 22 according to the invention and of the required dimensional setting for the diameter and spacing between the air nozzles 24 are shown in FIGS. 3a to 3c with respect to the arrangement 10 of the sonotrode 12 and the reflector 14 and also the paint nozzle 18. FIG. A shows a box-shaped air distributor 22 with air nozzles 26 which are arranged along the longitudinal axis and are fed via an air feed 23.

The sonotrode and the reflector are guarded against being wetted by the paint, in that cleaning air is directed between sheets of paint and the sonotrode or sheets and the reflector (FIG. 2). A closed ring for cleaning or directing air, as in the case of high-speed rotatary atomization, is not absolutely necessary in the case of ultrasonic standing-wave atomization. The round nozzles arranged in rows that are known from high-speed rotatary atomization have the advantage that the air stream reacts less sensitively to production tolerances than in the case of slotted nozzles and that a minimization of the air consumption is possible. Round nozzles are also technologically easier to produce than slotted nozzles. Therefore, round nozzles arranged in rows are preferred. In some cases, slotted nozzles may also be appropriate.

In the simplest case, the air cushion between sheets and sonotrode or sheets and reflector may be produced by round nozzles arranged linearly in a row (diameter about 0.5 to 1 mm; spacing several mm), which are located in an air distributor (box or tube form), to which air is fed at one point (FIG. 3a). In this way, the sonotrode and reflector are “cleaned” and at the same time the form of the paint spray mist is fixed.

To prevent parts of the spray mist reaching the sonotrode or the reflector, the bores may only have very small spacings. As a result, the zones of the air curtain with little air flow, through which the paint drops can fly, are kept small (FIG. 3b: I). These zones are produced by the small angle of aperture of the individual round nozzles (about 15° to 20°). To prevent paint drops from reaching the air distributor or the air tube (FIG. 3b: II; III), the air curtain has a specific width B when it enters the space between the reflector and the sonotrode (FIG. 3c). This is ensured when the distance A of the air discharge from the edge of the sonotrode or the edge of the reflector is great enough.

To ensure a compact construction of the atomizer, two (or more) parallel rows of nozzles are arranged in an air distributor (FIG. 4a). As a result, the required width B of the air curtain is already reached directly after emergence of the air, so that the distance A of the air distributor is minimal. The round nozzle of the two rows are in this case preferably arranged offset, in order to prevent paint droplets reaching the sonotrode and the reflector (FIG. 4a).

If the rows of nozzles are introduced into the air distributor such that they are inclined with respect to one another, the width of the air curtain in the atomization space increases only little (FIG. 4b). This arrangement of the rows of nozzles has the advantage that the form of the paint spray cone can be varied in a wide range with the aid of the cleaning air if the air distributors are provided in a rotatable and or displaceable manner (FIG. 5).

In the case of separate air distributors for the cleaning air and for the directing air, the cleaning air distributors prevent wetting of the sonotrode and reflector. The directing air distributors are rotatable and/or displaceable, so that the paint spray mist can be formed (FIG. 6: left-hand part). The separate setting or changing of the cleaning air or directing air is intended to have the effect of further reducing the air consumption. If the air distributors have only one row of nozzles in each case, the nozzles of the directing air and cleaning air are arranged offset (FIG. 6: bottom left). The fanning-out of the directing air curtain (FIG. 6f) supports the oval form of the paint spray cone better than a directing air curtain with parallel air conduction (FIG. 6e).

Lateral directing air distributors (FIG. 7) and segmented directing air distributors (FIG. 8 and FIG. 9) give rise to further advantageous possibilities for the forming of the paint spray cone.

Because of the unequal conditions at the sonotrode and the reflector, it may be that an asymmetrical setting or variation of the position of the air distributors for the cleaning air or directing air, of the air throughput and of the nozzle (diameter, spacing, inclination) is required. The variation of these parameters may also take place in dependence on the spatial position of the atomizer (with respect to gravitational acceleration).

By means of a rotatable block within a directing air distributor or directing-air distributor segment (FIG. 10), rows of nozzles or individual nozzles can be activated (deactivated), in order in this way to change the paint spray cone.

Different directing air characteristics can also be achieved if the directing air distributors has two or more nozzle characteristics and is rotatably arranged in a magazine (FIG. 11). This magazine has a sufficiently wide opening to release the respectively chosen row of nozzles (FIG. 11: A or B). The nozzle characteristic that is not required is sealed. The choice of nozzle characteristic A or B takes place by rotating the air directing distributor by about 180°.

To permit further variations, the directing air distributor can be turned back and forth within a magazine until the respective row of nozzles reaches the edges of the magazine opening. This region can be further widened if the magazine is adjustable.

The respective nozzle characteristics can be determined by the form of the row of nozzles (or number of rows) (FIG. 11: for example characteristic B—convex). Furthermore, the diameter, spacing and inclination of the nozzles may differ. To be able to prevent wetting of the reflector even when its distance from the paint tube (sheet of paint) is small and/or if very great rates of paint are required (for example delivery of the paint into a plurality of sound particle velocity antinodes), an air cushion is produced over the entire end face of the reflector (FIG. 12). This takes place by means of round nozzles which are uniformly distributed over the end face (for example nozzle diameter: 0.5 mm, spacing: 1-2 mm). Instead of many bores, the end face of the reflector may consist of a porous, air-permeable material. Sintered materials of glass or ceramic (for example so-called frits), of metal and plastic are suitable for this.

For an arrangement with an air cushion, at least directing air is additionally required, in order to transport the paint from the atomization space to the bodywork. If the bores in the reflector are given a specific direction, so that a flow acts obliquely against the directing air directly at the surface of the reflector, a particularly effective air cushion is produced.

In the same way, the sonotrode may be provided with an air cushion. Since said sonotrode is wetted less by the paint on account of its vibration, and because the feeding of air into the sonotrode is more complicated than in the reflector on account of the vibration, an annular air cushion around the sonotrode is advantageous (FIG. 12). The air cushion produced with this ring prevents paint from reaching the shell of the sonotrode, from which it is not removed by capillary wave atomization. Here, too, at least directing air is additionally required.

It is possibly sufficient to provide only regions of the reflector that are particularly at risk from wetting by paint with round nozzles. The same applies to the ring around the sonotrode. Furthermore, the reflector and the ring may comprise a number of segments, which are respectively supplied with air separately.

In the case of delivery of the paint into a plurality of sound particle velocity antinodes, the risk of paint tubes and paint distributors being wetted is great (cf. FIG. 3b: III). In order to prevent this, an air box which closely surrounds the paint tubes and produces a wide air flow (FIG. 13a) is fitted on the side of the ultrasonic atomizer facing away from the spraying direction. This air flow also serves for the uniform distribution of the paint drops over the cross section of the spray cone to the bodywork. The round nozzles are arranged in a way similar to in the case of the “reflector with air cushion” (cf. FIG. 12), or a porous sheet is likewise used.

If the air flow is given a twist, this has a stabilizing effect on the paint spray cone. For this purpose, the round nozzles are arranged on annular paths and inclined in the air box.

Under some circumstances, it is sufficient to arrange only round nozzles near the paint tubes in the air box (FIG. 13b).

In the case of a further variant, air tubes which reach up to close to the sheets of paint are fitted in the air box (FIG. 13c). These do not appreciably disturb the ultrasonic field and give the paint spray the desired direction near the location where it is produced.

Furthermore, with such needle-valve nozzles it is possible to prevent 2 neighboring sheets from spraying against one another and small drops from reuniting and thereby producing large drops.

The air box may comprise a number of segments, which are respectively supplied with air separately.

Since it is intended to work with as little cleaning and directing air as possible, under some circumstances a re-acceleration of the paint spray is required. For this purpose, directing air distributors are arranged underneath the sonotrode and the reflector (FIG. 14a). In this way, subsequent narrowing or widening of the paint spray cone is also possible.

The space between the sonotrode and the reflector is to be configured such that no vortexing of the paint spray occurs. This is to be realized by a funnel-shaped element which widens toward the opening (“trumpet”) and into which the sonotrode and the reflector are integrated in such a way that no tripping edges are produced for the disturbance. The vibrating sonotrode should be separated from the opening funnel by a narrow gap.

1. An ultrasonic standing-wave atomizer arrangement for producing a paint spray mist for painting a workpiece, with a sonotrode, with a component arranged lying opposite the sonotrode, a standing ultrasonic field being formed in the intermediate space between the sonotrode and the component in the case of operation, and with at least one paint feeding device, which introduces the paint into the intermediate space for the atomizing process at at least one paint discharge point, wherein there is an air supply device, which interacts with at least one air distribution device, wherein the air distribution device has a number of clearances, which serve for blowing out air, wherein the clearances are arranged in such a way that between the at least one paint discharge point and the sonotrode and also between the at least one paint discharge point and the component there is formed at least one region with a blocking air flow, by which air flow wetting of the sonotrode or of the component with paint is substantially avoided.

2. The ultrasonic standing-wave atomizer arrangement as claimed in claim 1, wherein the at least one air distribution device is a box-shaped hollow body or a corresponding piece of pipe.

3. The ultrasonic standing-wave atomizer arrangement as claimed in claim 1, wherein there are two air distribution devices, by which two blocking air flows that are independent of one another are formed.

4. The ultrasonic standing-wave atomizer arrangement as claimed in claim 1, wherein the clearances are configured as round nozzles.

5. The ultrasonic standing-wave atomizer arrangement as claimed in claim 1, wherein the clearances at an air distribution device are arranged in at least one row, wherein the clearances in a row under consideration are arranged at the same distances from one another along an imaginary straight line, and wherein a blocking air flow is formed by each row.

6. The ultrasonic standing-wave atomizer arrangement as claimed in claim 1, wherein the at least one air distribution device is at such a distance from the at least one paint discharge point and from the sonotrode or from the component that the thickness of the air flow required to avoid wetting is obtained, and the thickness can be empirically determined.

7. The ultrasonic standing-wave atomizer arrangement as claimed in claim 1, wherein the clearances at an air distribution device are arranged along at least two imaginary straight lines, wherein the at least two lines are parallel to one another, and wherein, seen in the transverse direction in relation to the imaginary lines, the clearances of one of the imaginary lines are arranged offset in relation to the clearances of at least one of the other imaginary lines.

8. The ultrasonic standing-wave atomizer arrangement as claimed in claim 1, wherein the clearances at one air distribution device are arranged along two imaginary straight lines, wherein the at least two lines are parallel to one another, and wherein the blocking air flows caused by the respective rows are directed slightly against one another, so that the overall thickness of the overall blocking air flow formed by the individual blocking air flow, in particular in the intermediate space, is comparatively small.

9. The ultrasonic standing-wave atomizer arrangement as claimed in claim 1, wherein an air distribution device is displaceable and/or pivotable for the purpose of influencing the form of the paint spray cone of the atomized paint, in particular is pivotable about a pivot axis parallel to one of the straight line.

10. The ultrasonic standing-wave atomizer arrangement as claimed in claim 1, wherein there is at least one directing-air distribution device, which interacts with the at least one air supply device, wherein the directing-air distribution device has a number of passages, which serve for the directed blowing out of air and the blown-out air for influencing the form of the atomized paint from at least one region with a directing air flow.

11. The ultrasonic standing-wave atomizer arrangement as claimed in claim 1, wherein the at least one directing-air distribution device is a box-shaped hollow body or a corresponding piece of pipe.

12. The ultrasonic standing-wave atomizer arrangement as claimed in claim 1, wherein the passages are configured as round nozzles.

13. The ultrasonic standing-wave atomizer arrangement as claimed in claim 1, wherein the at least one region of the directing air flow is formed approximately in the form of a cuboid or in the form of a fan by corresponding arrangement of the passages.

14. The ultrasonic standing-wave atomizer arrangement as claimed in claim 1, wherein the passages of a directing-air distribution device are arranged along at least one imaginary straight line, wherein this imaginary line being parallel to the clearance of the air distribution device assigned to the directing-air distribution device likewise arranged along a further imaginary line, and wherein, seen in the transverse direction in relation to the imaginary line, the passages are arranged offset in relation to the clearances.

15. The ultrasonic standing-wave atomizer arrangement as claimed in claim 1, wherein the regions of the directing air flows, optionally also in combination with the regions of blocking air flows, form a tunnel-like overall region of an air flow enclosing the atomized paint.

16. The ultrasonic standing-wave atomizer arrangement as claimed in claim 1, wherein the at least one directing-air distribution device is displaceable and/or pivotable for the purpose of influencing the form of the paint spray cone, in particular is pivotable about the longitudinal axis of the respective directing-air distribution device.

17. The ultrasonic standing-wave atomizer arrangement as claimed in claim 1, wherein the at least one air distribution device and/or the at least one directing-air distribution device are respectively subdivided into at least two segmental elements, wherein each segmental element has at least one clearance or a passage, and wherein the outflow direction of the air is separately settable for each segmental element of an air distribution device or a directing-air distribution device, in particular by pivoting them.

18. The ultrasonic standing-wave atomizer arrangement as claimed in claim 1, wherein the at least one air distribution device or the at least one directing-air distribution device is a blocking element, which blocking element blocks or releases at least one clearance or a passage for influencing the outflow of air.

19. The ultrasonic standing-wave atomizer arrangement as claimed in claim 18, wherein the blocking element is configured as a rotation block.

20. The ultrasonic standing-wave atomizer arrangement as claimed in claim 1, wherein the at least one directing-air distribution device has a directing air element, which is pivotably mounted in a holding element, wherein at least two different arrangements of apertures are arranged on the directing-air distributing element, wherein each arrangement of apertures is formed as a region with a defined directing air flow and wherein, depending on the pivoting position of the directing-air distributing element concerned, the outflow of air is released.

21. The ultrasonic standing-wave atomizer arrangement as claimed in claim 20, wherein the holding element is pivotable about the pivot axis of the directing-air distributing element.

22. The ultrasonic standing-wave atomizer arrangement as claimed in claim 20, wherein the holding element has a passage point, within which an opened arrangement of apertures is movable for adjusting purposes.

23. The ultrasonic standing-wave atomizer arrangement as claimed in claim 1, wherein a first distributor element, which interacts with the air supply device, is provided, wherein the first distributor element reaches around the sonotrode and/or the component and wherein arranged on the distributor element are first passages, through which air can be blown out in a directed manner, and wherein the directed air serves for forming an air cushion between the end face of the sonotrode or of the component that is facing the intermediate space and the at least one paint discharge point.

24. The ultrasonic standing-wave atomizer arrangement as claimed in claim 1, wherein the component and/or the sonotrode interacts with the air supply device, wherein second passages through which air flows out in a directed manner are arranged on the component and the sonotrode, respectively, and wherein the air flow flowing out in a directed manner serves for the formation of an air cushion between the end face of the component that is facing the intermediate space and the at least one paint discharge point.

25. The ultrasonic standing-wave atomizer arrangement as claimed in claim 23, wherein the first distributing elements are subdivided into segments, which are respectively supplied with air separately.

26. The ultrasonic standing-wave atomizer arrangement as claimed in claim 1, wherein a second distributing element is arranged on the side of the intermediate space lying opposite the spraying direction of the atomized paint, wherein the second distributing element serves for producing an air flow which completely encloses the atomized paint in the vicinity of the at least one paint discharge point and at least partly carries it along.

27. The ultrasonic standing-wave atomizer arrangement as claimed in claim 26, wherein the profile of the air flow can be set by the arrangement and alignment of apertures on the side of the second distributing element facing the at least one paint discharge point.

28. The ultrasonic standing-wave atomizer as claimed in claim 26, wherein the air flow has a twist about the longitudinal direction of the spraying direction, which twist stabilizes the air stream concerned.

29. The ultrasonic standing-wave atomizer arrangement as claimed in claim 1, wherein the free ends of pieces of pipe are arranged in the vicinity of the at least one paint discharge point, through which pieces of pipe air flows out in a directed manner, and wherein the outflowing air to a great extent prevents a recombination of atomized paint from different sheets of paint.

30. The ultrasonic standing-wave atomizer arrangement as claimed in claim 1, wherein at least one device for air distribution is arranged in the paint spraying direction below the intermediate space, and wherein the air distribution device spatially re-forms the spray cone of the atomized paint after the atomization phase in the intermediate space and if need be accelerates the paint particles.
